(19) United States
(12) Patent Application Publication
(10) Pub. No.: US 2006/0291946 A1
(43) Pub. Date: Dec. 28, 2006

(54) Ergonomic apparatus for keyboard

(75) Inventors: Daniel Lowry Odell, Kirkland, WA (US); David Michael Lane, Sammamish, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/165,715

(22) Filed: Jun. 24, 2005

(51) Int. Cl. G06F 3/023

(52) U.S. Cl. 400/715

(57) ABSTRACT

A plurality of embodiments of ergonomic apparatus for keyboards are provided for interfacing with a user's arms, wrists, hands and fingers in a more natural way, i.e., in ways that are optimally suited to human typing. The ergonomic apparatus for a keyboard includes structures that reduce extension of human hands while typing on the keyboard. An attachable frame component may be provided which, when attached to a keyboard near its front (the front being closest to the user), the frame component elevates the front of the keyboard thereby achieving a reverse slope of an upper surface of the keyboard.

### TECHNICAL FIELD

The present invention relates to ergonomic apparatus for keyboards. More particularly, the invention relates to an attachable frame for a keyboard for achieving a reverse tilt of the keyboard when attached.

### BACKGROUND

Ergonomic keyboards include structures that are well suited for human preferences as they relate to the peculiar angles and structures of human arms, wrists and hands. Vern Putz-Anderson et al.'s “Cumulative trauma disorders: A manual for musculoskeletal diseases of the upper limbs,” Taylor & Francis (1988) describes some typical motions that the hands undergo, for instance. For background purposes, such exemplary motions for a hand are shown and labeled in FIG. 1, and include neutral position, extension, radial deviation, flexion, ulnar deviation and pinch.

There are a number of present keyboard designs that have certain ergonomic features, i.e., features designed and arranged for use by people so that people can interact most efficiently and safely with those features; however, in some cases, such keyboard designs are based on research that is twenty or more years old. See M. Nakaseko, E. GrandJean and W. Hunting's “Studies on Ergonomically Designed Alphanumeric Keyboards,” The Human Factors Society, Human Factors 175-187 (1985), upon which, for instance, some current ergonomic keyboards, such as the Microsoft® Natural Keyboard, are based in part.

The design goals for the Natural Keyboard included improving wrist postures while typing: to reduce pronation, i.e., rotation of the hand and forearm so that the palm faces inwards or downwards (twisting palm over), accomplished in part by providing an 8 degree gable angle and reducing extension (bending hand backwards) accomplished in part by making keyboard slope adjustments and the presence of a fixed palm rest; and reducing ulnar deviation (twisting hand towards little finger) accomplished by the splitting the angle of the two keyboard halves.

While the Natural Keyboard improved upon human interaction with a keyboard input device relative to pre-existing keyboards, which tended to place greater consideration on the functionality enabled by the keys, further ergonomic improvements are nonetheless desired over the current Natural Keyboard. In one aspect, for instance, some ergonomic keyboards have been proposed for elevating the wrist rest of a keyboard with a plurality of pivotally attached tilt legs.

For instance, see U.S. Pat. No. 5,553,953, to Herman and Gramadino, for a first keyboard embodiment that achieves downward sloping of a keyboard away from a user by including pivotally attached tilt legs that elevate the wrist rest of a keyboard. When the pivotally attached tilt legs are in the extended or open position (i.e., having pivoted from the closed to the open position), the wrist rest of the keyboard is raised when the keyboard is laid down on a typically horizontal surface, achieving a downward slope of the keyboard surface away from the user. On the flip side, when the pivotally attached tilt legs are in the retracted or closed position (i.e., having pivoted from the open to the closed position), the surface of the keyboard is no longer reverse tilted, e.g., the keyboard lays substantially flat.

In another second keyboard embodiment disclosed in FIG. 4 of the '953 patent, a downwardly sloping upper surface is directly molded into the mount of the keyboard, making the angle at which the keyboard slopes downwardly away from the user a permanently fixed angle. With such a keyboard, whenever the keyboard is placed on a horizontal surface, the surface of the keyboard will always slope away from the user.

However, there are disadvantages to either approach disclosed in the '953 patent. In the former case, the provision of multiple pivotally attached tilt legs can raise manufacturing costs for a keyboard, which must include mechanical pivoting mechanisms that may wear down or out over time. Moreover, generally users exhibit a preference for one configuration of a keyboard or another and leave their keyboard in that configuration for long periods of time, and therefore users are not frequently flipping the pivotally attached tilt legs from the retracted position to the extended position, or vice versa. In a sense, tilt legs are therefore overly flexible for the realities of keyboard use.

In the second embodiment, just the opposite is the problem. When the keyboard includes a permanent reverse slope by providing a wedge shaped keyboard mount, there is no flexibility for a user (or a subsequent user of the keyboard) who may occasionally like to try a flat or other slope for the keyboard.

Thus, embodiments of a reverse slope keyboard which avoid the disadvantages, or illusory advantages, of pivotally attached tilt legs for keyboards and/or pre-determined and immutably sloped keyboards, while maintaining relatively low manufacturing costs are desirable.

### SUMMARY

In view of the foregoing, the present invention provides a plurality of embodiments of improved ergonomic apparatus and keyboards for interfacing with a user's arms, wrists, hands and fingers in a more natural way, e.g., in ways that are optimally suited to human comfort while typing. In one non-limiting aspect of the ergonomic apparatus for a keyboard of the invention, the structures of the apparatus and keyboard reduce extension of human hands while typing on the keyboard. In various non-limiting embodiments, the invention provides an attachable frame component which, when attached to a keyboard near its front (the front being closest to the user), elevates the front of the keyboard thereby achieving a reverse slope of an upper surface of the keyboard, i.e., downward sloping away from the user of the keyboard.

Other features of the present invention are described below.

### DESCRIPTION OF THE DRAWINGS

Embodiments of the ergonomic apparatus for keyboards of the invention are further described with reference to the accompanying drawings in which:

FIG. 1 illustrates exemplary hand motions and some exemplary illustrations and labels for describing the same;

FIG. 2 is a block diagram representing an exemplary non-limiting computing system environment in which the present invention may be implemented or utilized;

FIGS. 3A, 3B and 3C illustrate the positioning of one or more frame components under a keyboard for achieving reverse tilt of the keyboard in accordance with the invention;

FIG. 4 illustrates an exemplary non-limiting frame component in accordance with the invention;

FIGS. 5A and 5B illustrate an exemplary prototype keyboard including at least one exemplary non-limiting retaining mechanism for retaining a frame component in accordance with the invention;

FIGS. 6A, 6B, 6C, 6D, 6E and 6F illustrate exemplary side, bottom and perspective views of an exemplary prototype keyboard and frame component of the invention in various configurations;

FIGS. 7A, 7B, 7C and 7D serve to illustrate an exemplary non-limiting process of attaching (or detaching) a frame component of the invention to a keyboard including at least one retaining mechanism;

FIGS. 8A, 8B and 8C show further aspects and views of an exemplary non-limiting design of ergonomic frame component and keyboard in accordance with the invention; and

FIG. 9 illustrates an exemplary non-limiting design of a keyboard to illustrate that the frame component of the invention may work with a variety of ergonomic keyboards.

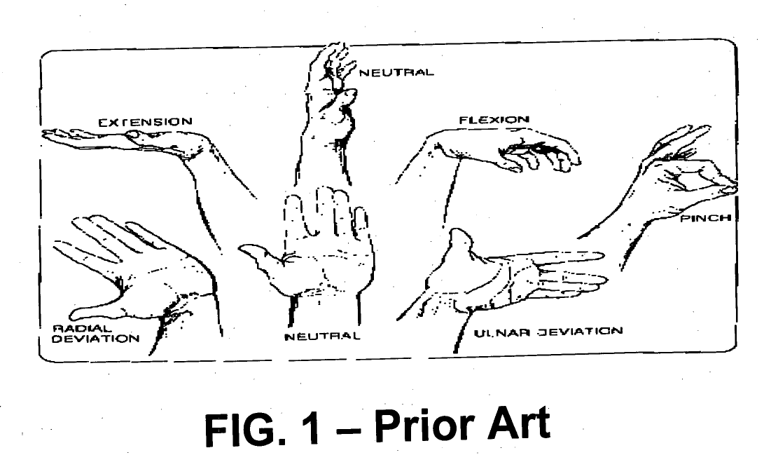

### DETAILED DESCRIPTION

Overview

As mentioned in the background, the present invention improves upon existing geometries of prior art ergonomic keyboards in new and beneficial ways, by providing a detachable frame for a keyboard that, when attached to the front of the keyboard from underneath, elevates the front of a keyboard, thereby achieving a reverse slope for an upper surface of the keyboard, e.g., where the keys of the keyboard reside, so that a user's wrists adopt a more comfortable posture when typing on the keyboard.

Among other benefits, the attachment of a frame in accordance with the invention to the underside of a keyboard helps to alleviate issues relating to extension of the human hand. In one embodiment, the frame is either attached or detached (not present), staying affixed to the underside of the keyboard when attached. In other embodiments, the frame is provided as a single component that may be provided with or sold separately from a keyboard. In other embodiments, the frame is attached to other places on the keyboard such as a front edge.

Exemplary Computing Environment

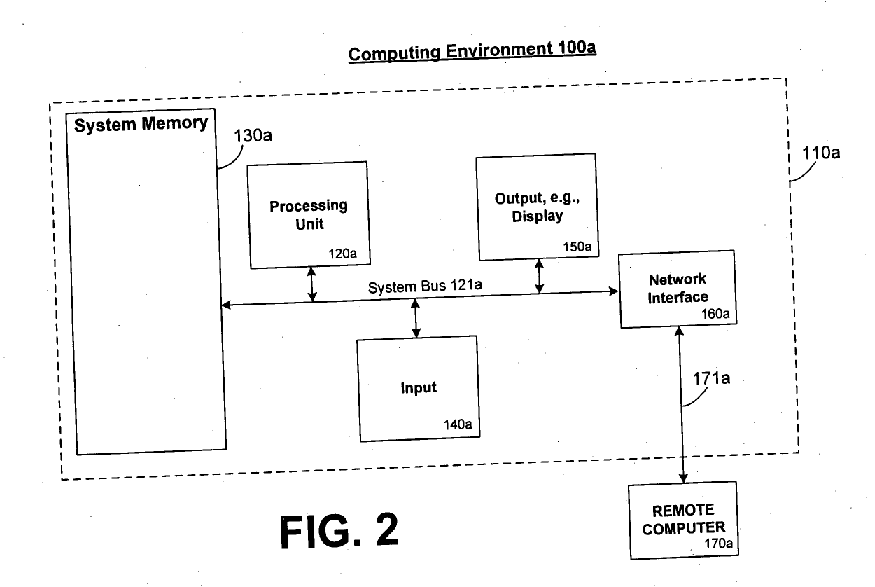

Since the apparatus of the invention attaches to a keyboard, the invention applies to any device wherein it may be desirable to provide input from a keyboard. It should be understood, therefore, that handheld, portable and other computing devices and computing objects of all kinds are contemplated for use in connection with certain embodiments of the present invention, wherever applicable, i.e., anywhere that a device may receive keyed input. Accordingly, the below general purpose remote computer described below in FIG. 2 is but one example, and the present invention may be implemented in connection with any computer.

Although not required, the apparatus of the invention can be provided with a keyboard that can interface with a computing device via an operating system, a service for a device or object, or any application software that operates in connection with keyed input. Those skilled in the art will appreciate that the ergonomic apparatus of the invention may be utilized with any keyboard with any computer system configurations and any protocols for communications of keyboard input.

FIG. 2 thus illustrates an example of a suitable computing system environment 100a in which the invention may be implemented, although as made clear above, the computing system environment 100a is only one example of a suitable computing environment and is not intended to suggest any limitation as to the scope of use or functionality of the invention. Neither should the computing environment 100a be interpreted as having any dependency or requirement relating to any one or combination of components illustrated in the exemplary operating environment 100a, or the ergonomic apparatus of the invention.

With reference to FIG. 2, an exemplary device that may be utilized in connection with the invention includes a general purpose computing device in the form of a computer 110a.

Components of computer 110a may include, but are not limited to, a processing unit 120a, a system memory 130a, and a system bus 121a that couples various system components including the system memory to the processing unit 120a. The system bus 121a may be any of several types of bus structures including a memory bus or memory controller, a peripheral bus, and a local bus using any of a variety of bus architectures.

Computer 110a typically includes a variety of computer readable media. Computer readable media can be any available media that can be accessed by computer 110a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110a. Communication media typically embodies computer readable instructions, data structures, program modules or other data in a modulated data signal such as a carrier wave or other transport mechanism and includes any information delivery media.

The system memory 130a may include computer storage media in the form of volatile and/or nonvolatile memory such as read only memory (ROM) and/or random access memory (RAM). A basic input/output system (BIOS), containing the basic routines that help to transfer information between elements within computer 110a, such as during start-up, may be stored in memory 130a. Memory 130a typically also contains data and/or program modules that are immediately accessible to and/or presently being operated on by processing unit 120a. By way of example, and not limitation, memory 130a may also include an operating system, application programs, other program modules, and program data.

The computer 110a may also include other removable/non-removable, volatile/nonvolatile computer storage media. For example, computer 110a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 121a through a non-removable memory interface such as an interface, and a magnetic disk drive or optical disk drive is typically connected to the system bus 121a by a removable memory interface, such as an interface.

A user may enter commands and information into the computer 110a through input devices, such as a keyboard (to which the ergonomic apparatus of the invention may attach) or a pointing device, commonly referred to as a mouse, trackball or touch pad. Other input devices may include a microphone, joystick, game pad, satellite dish, scanner, or the like. These and other input devices are often connected to the processing unit 120a through user input 140a and associated interface(s) that are coupled to the system bus 121a, but may be connected by other interface and bus structures, such as a parallel port, game port or a universal serial bus (USB). A graphics subsystem may also be connected to the system bus 121a. A monitor or other type of display device is also connected to the system bus 121a via an interface, such as output interface 150a, which may in turn communicate with video memory. In addition to a monitor, computers may also include other peripheral output devices such as speakers and a printer, which may be connected through output interface 150a.

The computer 110a may operate in a networked or distributed environment using logical connections to one or more other remote computers, such as remote computer 170a, which may in turn have media capabilities different from device 110a. The remote computer 170a may be a personal computer, a server, a router, a network PC, a peer device or other common network node, or any other remote media consumption or transmission device, and may include any or all of the elements described above relative to the computer 110a. The logical connections depicted in FIG. 2 include a network 171a, such local area network (LAN) or a wide area network (WAN), but may also include other networks/buses. Such networking environments are commonplace in homes, offices, enterprise-wide computer networks, intranets and the Internet.

When used in a LAN networking environment, the computer 110a is connected to the LAN 171a through a network interface or adapter. When used in a WAN networking environment, the computer 110a typically includes a modem or other means for establishing communications over the WAN, such as the Internet. A modem, which may be internal or external, may be connected to the system bus 121a via the user input interface of input 140a, or other appropriate mechanism. In a networked environment, program modules depicted relative to the computer 110a, or portions thereof, may be stored in a remote memory storage device. It will be appreciated that the network connections shown and described are exemplary and other means of establishing a communications link between the computers may be used.

Ergonomic Apparatus for Keyboards

Having described some exemplary environments for operation of a keyboard to which the apparatus of the invention may attach, as mentioned, the invention relates to an apparatus, or frame component, for an improved keyboard, such as may be used in connection with a computing device, such as a personal computer, terminal, portable computer, kiosk or the like. The ergonomic structures and benefits enabled by the invention can be provided separately from the keyboard. As described in various embodiments below, improved wrist postures are taken into account for the improved structures and implementations of an ergonomic frame for a keyboard in accordance with the invention.

As mentioned, the invention provides a device that achieves a negative tilt angle for a keyboard from the perspective of the user of the keyboard. A prototype of the device of the invention is described herein in the context of a frame component on which the keyboard sits and to which the keyboard is attached, to provide either fixed or adjustable negative (or positive tilt), whereby the keyboard can either attach to the frame component, or just sit on top of the frame component (e.g., interlocking or fitting geometries, or via grooves in the keyboard). A tray component may also be provided on which the keyboard, or most of the keyboard rests, which is designed to provide a negative tilt relative to when the tray component is absent.

While some descriptive detail is shown for the frame component embodiment herein, it can be appreciated that there are other methods of achieving the same or similar result. For instance, the invention can be implemented by providing removable non-pivoting legs, or built in legs, or a heightened support surface, on the front of the keyboard, elevating the front of the keyboard, and thereby achieving negative tilt. Linearly extending legs, e.g., ratcheting legs that extend from the bottom of the keyboard, may also be provided to achieve negative tilt. Thus, one of ordinary skill in the art will recognize that a variety of means for elevating the front of a keyboard are contemplated within the spirit of the invention.

As mentioned, in one embodiment of the invention, two separate components are provided: a keyboard, and an elevation frame. One way to engage the frame with the keyboard is via lining up edge(s) of the frame with corresponding groove(s) of the keyboard. The elevation frame slidably engages with the underside of the keyboard to elevate the portion of the keyboard proximate to the user, i.e., to elevate the side of the keyboard from which the user's hands approach the keyboard to achieve a “reverse tilt” of the plane of the keyboard.

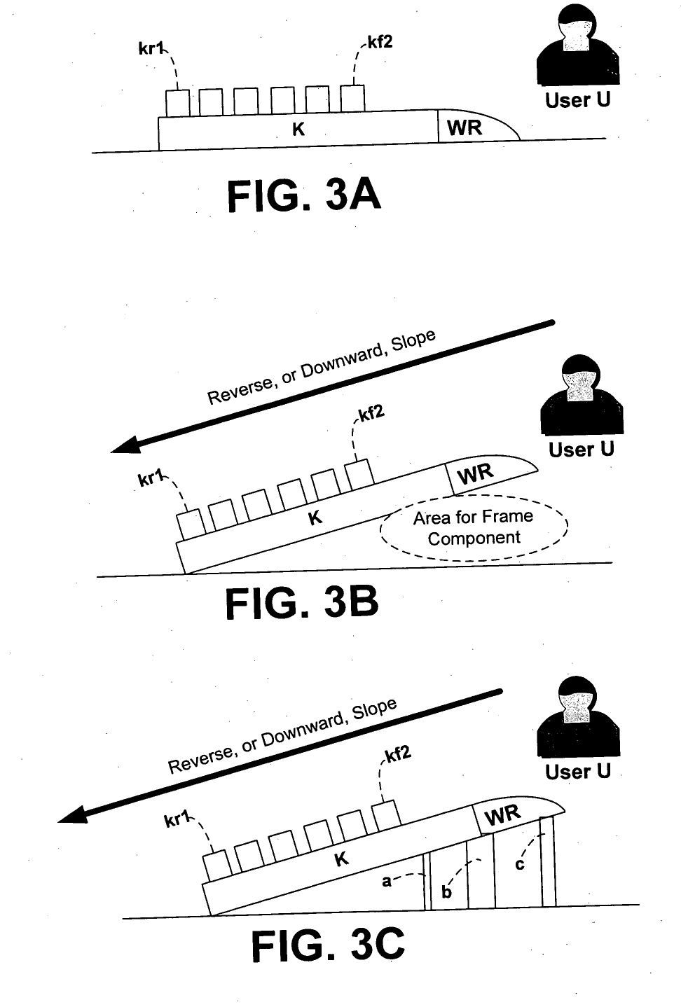

An exemplary generic keyboard K, representing any keyboard for a computing device as described above, is shown having an optional wrist rest WR in FIG. 3A, intended to encompass all known wrist rest embodiments, including split wrist rest sections, gel or plastic embodiments, detachable or affixed to the keyboard mount, etc, as can be appreciated by one of ordinary skill in the wrist rest art. Keyboard K also includes at least one key kf at the front of the keyboard K (i.e., the front being closest to a user U of the keyboard K and generally the part that includes a wrist rest WR, if a wrist rest is present) and at least one key kr at the rear of the keyboard (i.e., the rear being farthest from the user U of the keyboard K). When the frame component of the invention occupies the space underneath the keyboard K (i.e., is attached to the front of the keyboard K), the effect is to tilt the keyboard K giving it an ergonomic reverse slope from the perspective of the user U.

In accordance with the present invention, underneath the keyboard K, at or near the front of the keyboard K, generally away from the center of gravity of the keyboard K to provide a stable result that does not teeter, a frame component is attached to the keyboard K in the area for the frame component as illustrated in FIG. 3B. As shown in FIG. 3C, the block representations a, b and c of the frame component of the invention show that different alternatives for positions, shapes, lengths and thicknesses (and corresponding strengths), may all be used for a frame component in accordance with the invention. For instance, block representation a shows a frame component that is relatively short compared to block representation c to support the same reverse slope angle. For another variation, block representation b is shown underneath and attached to part of the mount of keyboard K, but also to the wrist rest WR. It is thus noted that any such different design choices for a frame component are contemplated in accordance with the invention.

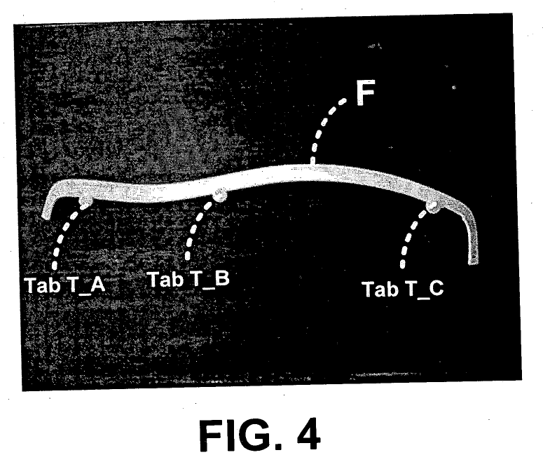

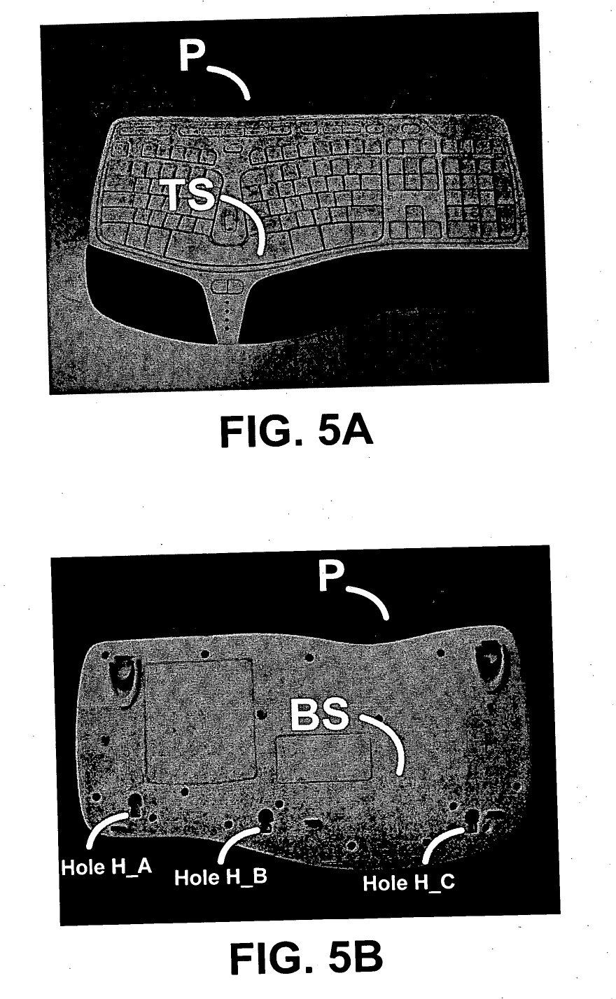

An exemplary non-limiting elevation frame F for elevating a keyboard in accordance with the invention, including the plastic tabs T_A, T_B and T_C for attaching the frame F to a keyboard is shown in the illustration of FIG. 4. An exemplary non-limiting keyboard prototype P to which such a frame F may attach is illustrated in FIG. 5A. As shown, the keyboard prototype P has a top surface TS that includes exemplary non-limiting key layout, exemplary non-limiting shape(s) and thickness(es) of the keyboard mount and exemplary non-limiting dual wrist rest sections. As shown in FIG. 5B, the bottom surface BS of the prototype P includes Holes H_A, H_B and H_C, for coupling with the Tabs T_A, T_B and T_C of frame F to attach frame F to the bottom surface BS of prototype P.

The bottom of the prototype P may also optionally include plastic pieces that elevate the back side of the keyboard as well, as shown in FIG. 5B (i.e., the part of the keyboard farthest from the user).

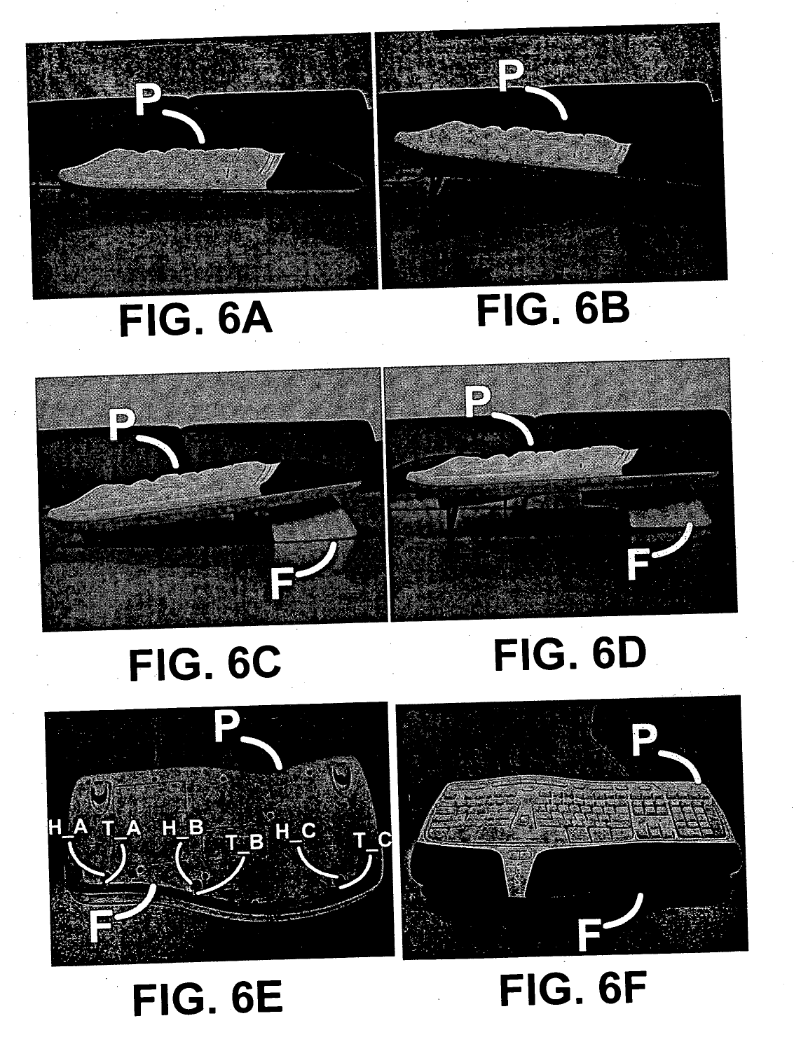

FIGS. 6A to 6D show exemplary non-limiting prototype P in a flat position with respect to the table surface on which the keyboard rests (FIG. 6A), in a forward tilted position sloped upwards away from a user of the prototype P via tilt legs positioned on the back of the prototype P (FIG. 6B), in a reverse tilted position sloped downwards away from a user of the prototype P via frame F of the present invention (FIG. 6C), and in a generally flat or slightly tilted position (either forward or reverse) when both the tilt legs on the back of the prototype P are extended and the frame F of the present invention is coupled to prototype P (FIG. 6D).

FIGS. 6E and 6F show exemplary non-limiting views of a prototype P having a frame F of the invention coupled thereto from a bottom plan view perspective view and forward perspective view from the sightline of a hypothetical user, respectively. As shown well by FIG. 6E (the bottom plan view), the tabs T_A, T_B and T_C of the frame F slidably engage keyhole shaped holes H_A, H_B and H_C of the bottom of the prototype P to couple the frame F to the prototype P. As shown by FIG. 6F, a user of the prototype P including frame F underneath would type on a downwardly sloping surface, from front of the prototype P to the rear.

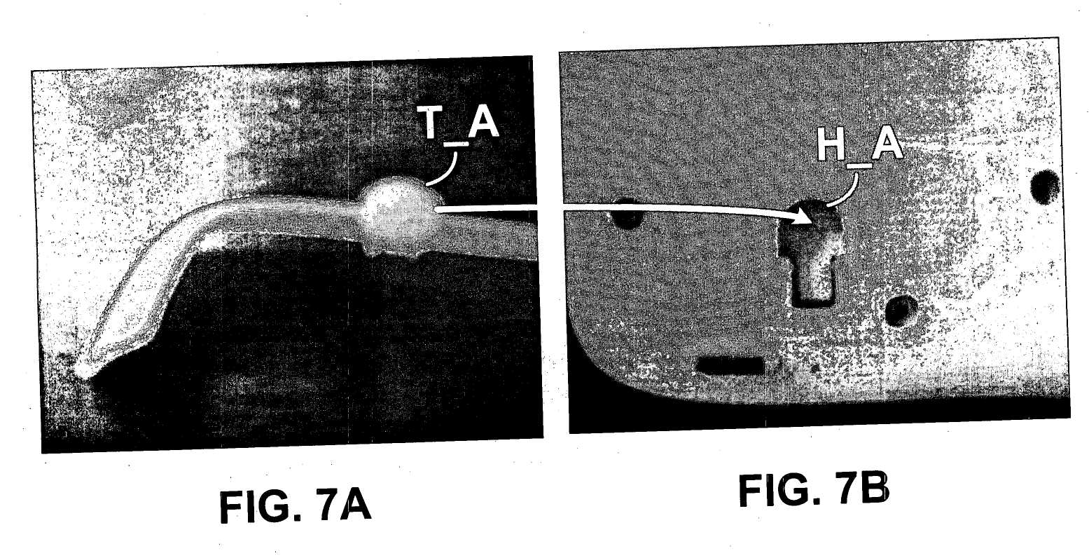

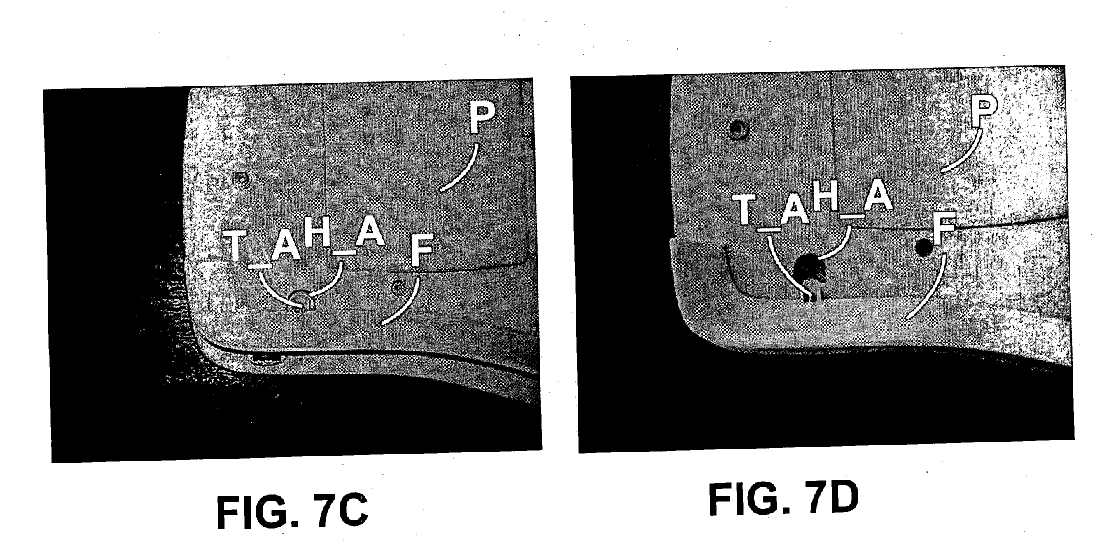

As mentioned and illustrated in FIGS. 6C, 6E and 6F, the elevation frame F elevates the front side of the keyboard, i.e., the part of the keyboard closest to the user near the wrist pad. In this regard, each of tabs T_A, T_B and T_C of the elevation frame F slidably engage holes H_A, H_B and H_C of the underside of the keyboard. FIGS. 7A and 7B illustrate this conceptually for one of the tabs T_A and one of the holes H_A. As shown in exemplary non-limiting fashion, each of the tabs is substantially rounded and is attached to the end of an extension piece that is narrower than the rounded tab itself, whereas each of the holes has a substantially round portion and a rectangular portion. As shown by the arrow from tab T_A of FIG. 7A to hole H_A of FIG. 7B, to engage tab T_A with hole H_A, the substantially rounded tab T_A is inserted into the substantially round portion of the hole H_A, as shown by the arrow.

If tab T_A is placed into the rounded portion of hole H_A as described in connection with FIGS. 7A and 7B, then the keyboard is configured as shown in FIG. 7C, in which tab T_A of frame F is shown in the rounded portion of hole H_A of prototype P. Yet, the elevation frame F is still disengageable as shown in FIG. 7C because nothing yet prevents tab T_A from being removed orthogonally from hole H_A. However, if the elevation frame F and thus tab T_A slides toward the rectangular portion of the hole H_A, then the elevation frame is secured to the keyboard such that if the keyboard is turned over again (keys upward), the elevation frame will not disengage from gravity because the rounded tab T_A is wider than the rectangular portion of hole H_A. The frame F is shown engaged to prototype P in such a manner in FIG. 7D. In the presently described embodiment of frame F, each of tabs T_B and T_C engage holes H_B and H_C in a similar manner.

In summary of the prototype and elevation frame structures of the invention, the elevation frame F has rounded tabs that engage a rounded portions of keyhole shaped holes in a direction that is orthogonal to the undersurface of the keyboard. Then, the rounded tabs of the elevation frame are secured to the underside of the keyboard by sliding the elevation frame, and thus the tabs, towards the rectangular portions of the keyhole shaped holes in the plane of the undersurface of the keyboard, as illustrated in FIG. 7D. Once the keyboard is turned over so that the keys are presented to the user for use, the keyboard appears as shown in FIG. 6F.

It should be understood that FIGS. 4 to 7D illustrate but one non-limiting implementation of a keyboard and elevation frame of the invention and that all permutations and combinations of any of the above-described features are considered within the spirit of the improved ergonomic apparatus for keyboards of the invention.

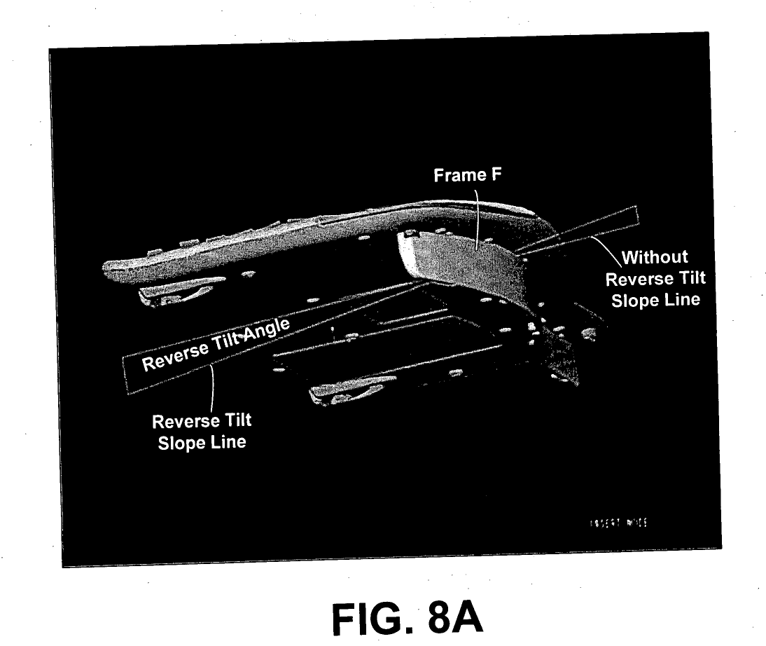

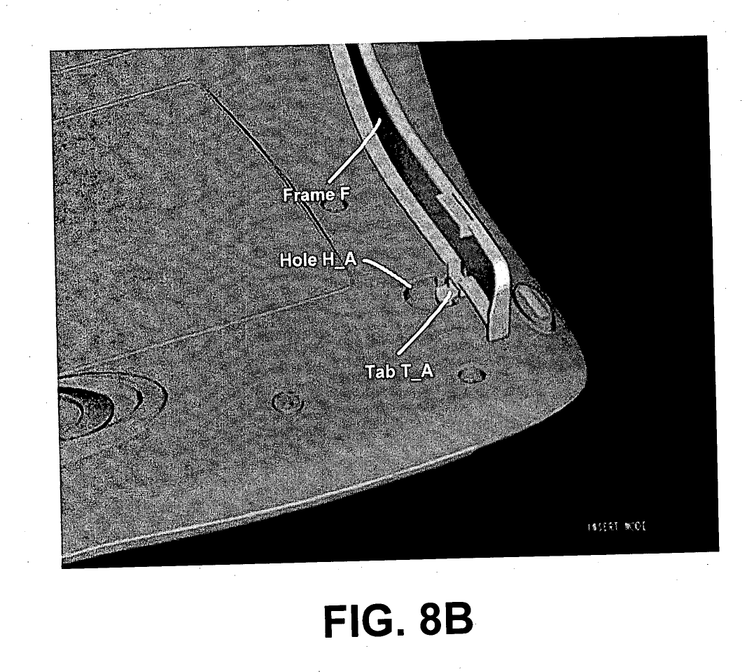

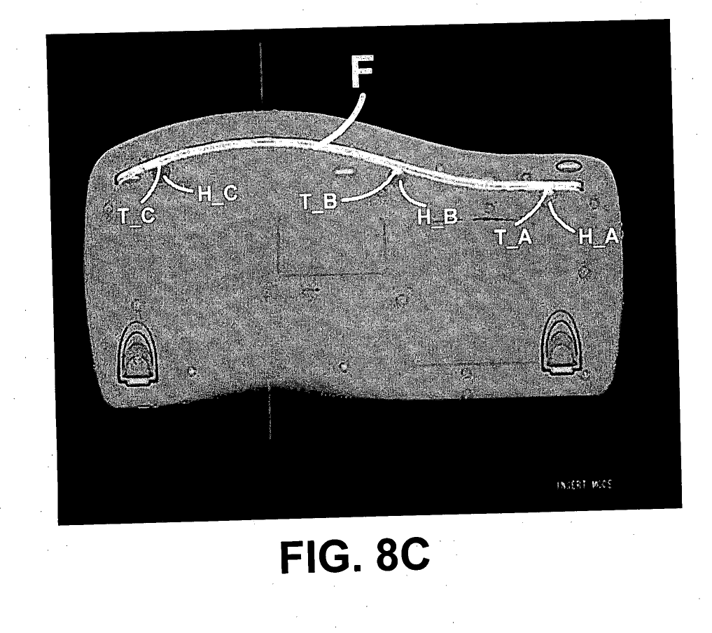

FIG. 8A illustrates the difference of orientation of a keyboard including the frame F embodiment of the invention. There it shows the orientation of the (substantial) plane of the keyboard mount when reverse tilted with the frame, as compared to the orientation of the substantial plane of the keyboard mount when the frame is absent, illustrating the angle achieved by the reverse tilt frame F. FIG. 8B illustrates the coupling of a tab T_A with a hole H_A in more detail in accordance with the frame embodiment of the invention. FIG. 8C illustrates a more detailed bottom plan view of the keyboard when coupled with the frame embodiment F of the invention including the slidable engagement of tabs T_A, T_B and T_C with holes H_A, H_B and H_C, respectively.

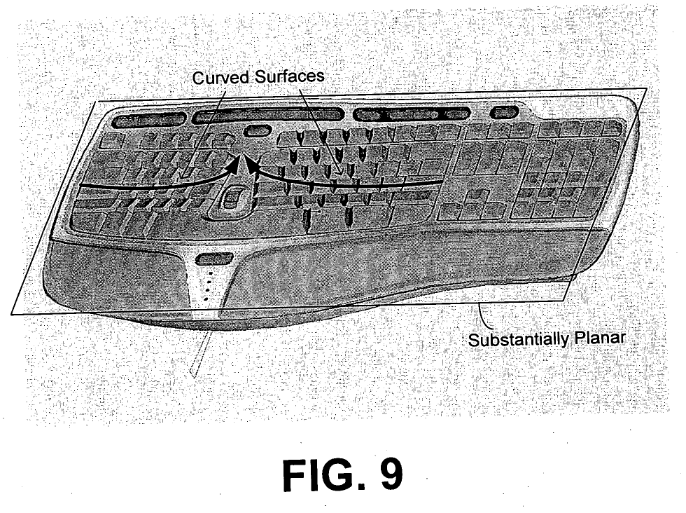

Finally, FIG. 9 illustrates an exemplary ergonomic keyboard to which any of the elevation components described herein may couple to provide reverse tilt. The keyboard of FIG. 9 includes sloping key surfaces on the top of the keyboard, which by themselves, are ergonomic in some respects. It can thus be appreciated that the invention applies to any keyboard which defines a substantially planar mount, however, the actual surfaces or keys may curve, slant or bend.

Where appropriate, any of the various structures and techniques described herein may be implemented in connection with hardware, including electro mechanical parts, or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, such as any of the embodiments of an ergonomic keyboard of the invention, and at least one output device. However, the program(s) can be implemented in assembly or machine language, if desired. In any case, the language may be a compiled or interpreted language, and combined with hardware implementations.

Additionally, while the present invention has been described in connection with the preferred embodiments of the various figures, it is to be understood that other similar embodiments may be used or modifications and additions may be made to the described embodiment for performing the same function of the present invention without deviating therefrom. Therefore, the present invention should not be limited to any single embodiment, but rather should be construed in breadth and scope in accordance with the appended claims.

What is claimed is:

1. A keyboard for providing input to a computing device, including:
a substantially planar keyboard mount; and
at least one section of keys extending from an upper surface of the substantially planar keyboard mount for receiving fingered key input from a user of the keyboard,
wherein said substantially planar keyboard mount includes at least one coupling component for coupling a pre-fixed elevation component to a bottom surface of the substantially planar keyboard mount, whereby when the pre-fixed elevation component is coupled to the bottom surface via said at least one coupling component, a portion of the substantially planar keyboard closest to the user is elevated, relative to when the pre-fixed elevation component is not coupled to the bottom surface.

2. A keyboard according to claim 1, wherein said substantially planar keyboard mount is sloped downwards away from the perspective of the user of the keyboard when the pre-fixed elevation component is coupled to the bottom surface.

3. A keyboard according to claim 1, wherein said at least one coupling component is located on said bottom surface of said substantially planar keyboard mount.

4. A keyboard according to claim 1, wherein said at least one coupling component includes a hole defined by a wide hole portion and a narrow hole portion, whereby at least one tab of the pre-fixed elevation component attaches and detaches via said wide hole portion and remains coupled to the substantially planar keyboard mount via said narrow hole portion.

5. A keyboard according to claim 1, wherein said at least one coupling component is positioned towards the user relative to the center of the substantially planar keyboard as defined by its center of gravity.

6. A keyboard according to claim 1, wherein said pre-fixed elevation component is a tray upon which the substantially planar keyboard mount rests via gravity and said at least one coupling component is the shape of the substantially planar keyboard mount adhering to the shape of the tray.

7. A keyboard according to claim 1, wherein said pre-fixed elevation component is a frame component for coupling to the front of the substantially planar keyboard mount.

8. A keyboard according to claim 1, wherein said pre-fixed elevation component is a frame component for coupling to the front of the substantially planar keyboard mount.

9. A keyboard according to claim 1, wherein said pre-fixed elevation component is at least one removable non-pivoting leg for coupling to the front of the substantially planar keyboard mount.

10. A keyboard according to claim 9, wherein said at least one removable non-pivoting leg for coupling to the front of the substantially planar keyboard mount is at least one linearly extending leg that extends substantially orthogonally from the bottom surface.

11. An ergonomic apparatus for a keyboard having a substantially planar keyboard mount that provides key input to a computing device, including:
an elevation frame for supporting a front side of the keyboard closest to a user of the keyboard; and
at least one extended component for coupling to at least one coupling component of a bottom surface of the substantially planar keyboard mount, whereby when the elevation frame is coupled to the bottom surface via said at least one extended component coupled to said one coupling component, a portion of the substantially planar keyboard closest to the user is elevated, relative to when the elevation frame is not coupled to the bottom surface.

12. An ergonomic apparatus according to claim 11, wherein the at least one extended component is at least one tab that fits into the at least one coupling component at a wide portion thereof and then becomes coupled to the at least one coupling component by slidably engaging the at least one tab with a narrow portion of the at least one coupling component.

13. An ergonomic apparatus according to claim 11, wherein said substantially planar keyboard mount is sloped downwards away from the perspective of the user of the keyboard when the elevation frame is coupled to the bottom surface.

14. A keyboard according to claim 11, wherein said elevation frame is a tray upon which the substantially planar keyboard mount rests via gravity and said at least one extended component are the edges of the tray interfacing with the shape of the substantially planar keyboard mount.

15. A keyboard for providing input to a computing device, including:
means for mounting keys of at least one key section of the keyboard,
wherein said means for mounting keys includes at least one means for coupling and decoupling a means for elevating a front of the keyboard from the perspective of a user, whereby when the means for elevating is coupled to a bottom surface of the means for mounting keys via said at least one means for coupling, a portion of the means for mounting keys closest to the user is elevated, relative to when the means for elevating is not coupled to the bottom surface.

16. A keyboard according to claim 15, wherein said means for mounting keys is sloped downwards away from the perspective of the user of the keyboard when the means for elevating is coupled to the bottom surface.

17. A keyboard according to claim 15, wherein said at least one means for coupling is on said bottom surface of said means for mounting keys.

18. A keyboard according to claim 15, wherein said at least one means for coupling is positioned towards the user relative to the center of the means for mounting keys as defined by the center of gravity of the means for mounting keys.

19. A keyboard according to claim 15, wherein said means for elevating is substantially undetachable and unmovable when coupled to the bottom surface of the means for mounting keys.

20. A keyboard according to claim 15, wherein said means for elevating extends along the front side of the means for mounting keys from the perspective of the user, substantially extending across the means for mounting keys.
